(19) United States
(12) Patent Application Publication
(10) Pub. No.: US 2025/0209755 A1
(43) Pub. Date: Jun. 26, 2025

(54) METHOD AND SYSTEM FOR GENERATING AR IMAGE PLAYED BACK ON REMOTE MOBILE DEVICE

(71) Applicant: Korea Electronics Technology Institute, Seongnam-si (KR)

(72) Inventors: Jun-Hwan Jang, Paju-si (KR); Woo Chool Park, Incheon-si (KR); Minsu Choi, Seoul (KR); Jun Suk Lee, Seoul (KR); Bonjae Koo, Suwon-si (KR)

(21) Appl. No.: 18/999,327

(22) Filed: Dec. 23, 2024

(30) Foreign Application Priority Data
Dec. 22, 2023 (KR) 10-2023-0190312

(51) Int. Cl. G06T 19/00; G06T 15/00; H04N 21/81

(52) U.S. Cl. CPC G06T 19/006; G06T 15/005; H04N 21/816

(57) ABSTRACT

Proposed are a method and system for generating an augmented reality (AR) image that is played back on a remote mobile device. The method may include generating, by a mobile device, based on a camera image and sensor data collected from a camera and a sensor mounted on the mobile device, pose information of the mobile device and geometric information of the camera image. The method may also include generating, by a rendering server, a color image and a depth image of a virtual object based on the pose information and 3D scene data of the virtual object. The method may further include generating, by the mobile device, a mixed reality image based on the color image, the depth image, the camera image, and the geometric information.

### CROSS-REFERENCE TO RELATED APPLICATION

This application claims priority to and the benefit of Korean Patent Application No. 10-2023-0190312, filed on Dec. 22, 2023, the disclosure of which is incorporated herein by reference in its entirety.

### BACKGROUND

### Technical Field

The present disclosure relates to a method and system for generating an augmented reality (AR) image capable of being played back by a low-spec AR device.

### Description of Related Technology

In the case of augmented reality (AR) and mixed reality (MR) advanced therefrom, when the real world and virtual objects are not completely merged, a sense of dissonance is generated and the impact of the content is lost.

To resolve this issue, expensive high-performance devices such as HoloLens 2 and methods of fully identifying information (a distance, a direction, a depth, etc.) of the real world and placing and rendering virtual objects have emerged.

### SUMMARY

One aspect is a method and system for generating an augmented reality (AR) image, in which a rendering server renders an AR object and transmits a rendering result image in a 2D format to a mobile device, and the mobile device decodes the received image and synthesizes the decoded image with a camera image thereof and outputs a synthesized result.

Another aspect is a method and system for generating an AR image, in which a rendering server transmits a depth image corresponding to 3D data of an AR object to a mobile device, and the mobile device compares the depth of the object with that of a real object to perform appropriate occlusion.

Aspects of the present disclosure are not limited to the disclosed herein, and other aspects may become apparent to those of ordinary skill in the art based on the following description.

Another aspect is a method of generating an AR image, which includes: generating, by a mobile device, based on a camera image and sensor data collected from a camera and a sensor mounted on the mobile device, pose information of the mobile device and geometric information of the camera image; generating, by a rendering server, a color image and a depth image of a virtual object based on the pose information and 3D scene data of the virtual object; and generating, by the mobile device, a mixed reality image based on the color image, the depth image, the camera image, and the geometric information.

The generating of the color image and the depth image may include: performing, by the rendering server, a render pass based on the pose information and the 3D scene data of the virtual object to generate the color image, a scene depth, and a scene normal vector; and performing an AR render pass based on the color image, the scene depth, and the scene normal vector to generate the depth image.

The depth image of the virtual object may be a colorized depth image.

The depth image of the virtual object may be represented in a log scale when depth information of a specific point included in the depth image of the virtual object is greater than a predetermined reference value.

Another aspect is a system for generating an AR image, which includes: a mobile device; and a rendering server, wherein the mobile device, based on a camera image and sensor data collected from a camera and a sensor mounted on the mobile device, generates pose information of the mobile device and geometric information of the camera image, the rendering server generates a color image and a depth image of a virtual object based on the pose information and 3D scene data of the virtual object, and the mobile device generates a mixed reality image based on the color image, the depth image, the camera image, and the geometric information.

The rendering server may perform a render pass based on the pose information and the 3D scene data of the virtual object to generate the color image, a scene depth, and a scene normal vector, and perform an AR render pass based on the color image, the scene depth, and the scene normal vector to generate the depth image.

The depth image of the virtual object may be a colorized depth image.

The depth image of the virtual object may be represented in a log scale when depth information of a specific point included in the depth image of the virtual object is greater than a predetermined reference value.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings.

FIG. 1 is a block diagram illustrating the configuration of a system for generating an augmented reality (AR) image according to one embodiment of the present disclosure.

FIG. 2 is a reference diagram illustrating an AR image generation process through a direct rendering method of a rendering server according to one embodiment of the present disclosure.

FIG. 3 is a reference diagram illustrating an AR image generation process through a virtual camera method of a rendering server according to one embodiment of the present disclosure.

FIG. 4 is a diagram illustrating a depth image representation algorithm;

FIG. 5 is a diagram illustrating changes in RGB values according to a depth image representation algorithm.

FIG. 6 is an example illustrating the application of a depth image representation algorithm to an actual object.

FIG. 7 is a diagram illustrating a depth image representation algorithm;

FIG. 8 is a flowchart for describing a method of generating an AR image according to one embodiment of the present disclosure.

FIG. 9 is a block diagram illustrating a computer system for implementing a method of generating an AR image according to an embodiment of the present disclosure.

### DETAILED DESCRIPTION

Mobile devices, especially low-spec AR devices, such as smart glasses, lack performance, making it difficult or impossible to render high-quality AR objects.

Therefore, in order to display high-quality AR objects on low-spec mobile devices, rendering images need to be provided to the mobile devices from an external server. In this case, in order to ensure real-time playback performance, the rendering time needs to be shortened. In addition, to merge the real world and the virtual world, depth information of virtual objects needs to be provided in the mobile information from an external server, and in order to completely merge the real world and the virtual world, the depth information of the virtual object needs to be precisely represented.

The list of applications referenced in the present disclosure by the applicant is as follows: (1) and (2). In this specification, the methodology proposed in each application may be referred to with the numbers assigned to the respective applications as follows. The entire contents of the specifications of applications (1) and (2) are incorporated herein by reference.
(1) An XR streaming system for a lightweight XR device and an operation method thereof (Application No.: KR 10-2021-0144554, Application Date: 2021 Oct. 27)
(2) An apparatus and method for encoding real-time augmented reality object using a virtual camera (Application No.: KR 10-2022-0161200, Application Date: 2022 Nov. 28)

The present disclosure relates to a method and system for generating an augmented reality (AR) image played back on a remote mobile device. A mobile device with sufficient performance, such as a smartphone, does not have difficulty rendering a high-quality AR object, but a low-spec AR device, such as smart glasses, has difficulty rendering a high-quality AR object due to insufficient performance. However, since most mobile chipsets have a built-in hardware-based video decoder, even low-spec AR devices may perform video decoding. Considering this, a system for generating an AR image according to an embodiment of the present disclosure adopts a method in which a rendering server renders an AR object and transmits a resulting screen (a color image) in a 2D form to a mobile device, and the mobile device decodes the received image, synthesizes the decoded image with its own camera screen, and then outputs the synthesized result. The present disclosure aims to provide a method and system for generating an AR image in which a screen that is to be displayed on a remote mobile device (an AR device) is rendered by a server on behalf of the remote mobile device, thereby providing perception of a high-quality AR object being played back on the remote mobile device.

In order for a mobile device to output an AR object, three-dimensional data of the object is required, and thus the rendering server needs to additionally transmit a depth image to the mobile device. In addition, the AR object needs to be aligned with the real world, and when the object overlaps an object in the real world, appropriate occlusion needs to be performed. In other words, the image of the AR object needs to be displayed over a real-world scene, and the AR object in the image needs to be occluded by an object that exists in reality. To this end, a mobile device according to one embodiment of the present disclosure directly calculates geometric information of the real world and pose information of the device. The rendering server receives the pose information of the mobile device, renders an AR image at a corresponding point in time, and transmits the AR image to the mobile device, and the mobile device reflects the geometric information in the camera image and the rendering image to generate and display a mixed reality image with occlusion applied.

The advantages and features of the present disclosure and ways of achieving them will become readily apparent with reference to the detailed description of the following embodiments in conjunction with the accompanying drawings. However, the present disclosure is not limited to such embodiments and may be embodied in various forms. The embodiments to be described below are provided only to complete the disclosure of the present disclosure and assist those of ordinary skill in the art in fully understanding the scope of the present disclosure, and the scope of the present disclosure is defined only by the appended claims. Terms used herein are used to aid in the description and understanding of the embodiments and are not intended to limit the scope and spirit of the present disclosure. It should be understood that the singular forms “a” and “an” also include the plural forms unless the context clearly dictates otherwise. The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof.

In the description of the present disclosure, when it is determined that a detailed description of related technology may unnecessarily obscure the gist of the present disclosure, the detailed description will be omitted.

Hereinafter, example embodiments of the present disclosure will be described with reference to the accompanying drawings in detail. For better understanding of the present disclosure, the same reference numerals are used to refer to the same elements throughout the description of the figures.

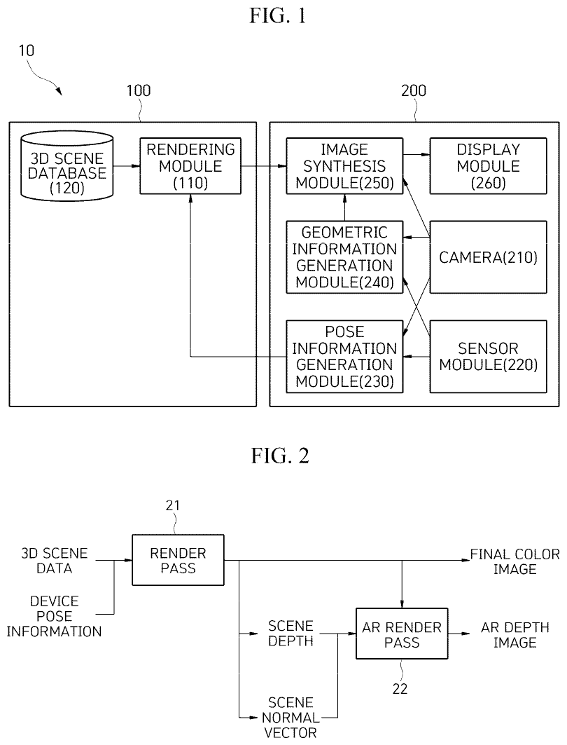

FIG. 1 is a block diagram illustrating the configuration of a system for generating an AR image according to one embodiment of the present disclosure.

A system 10 for generating an AR image according to one embodiment of the present disclosure includes a rendering server 100 and a mobile device 200. The rendering server 100 and the mobile device 200 may be located far apart from each other. The rendering server 100 and the mobile device 200 communicate with each other via a wired/wireless network. The rendering server 100 includes a rendering module 110 and a 3D scene database (DB) 120. The mobile device 200 includes a camera 210, a sensor module 220, a pose information generation module 230, a geometric information generation module 240, an image synthesis module 250, and a display module 260.

The rendering server 100 and the mobile device 200 shown in FIG. 1 are based on one embodiment, and the components of the rendering server 100 and the mobile device 200 according to the present disclosure are not limited to the embodiment shown in FIG. 1, and some components may be added, changed, or omitted as needed.

The camera 210 transmits an image of the real world (hereinafter referred to as “a camera image”) acquired by the camera 210 to the pose information generation module 230, the geometric information generation module 240, and the image synthesis module 250.

The sensor module 220 includes one or a combination of a gyro sensor, a geomagnetic sensor, and an acceleration sensor, and transmits sensor data acquired using the sensor to the pose information generation module 230 and the geometric information generation module 240.

The pose information generation module 230 generates pose information of the mobile device 200, i.e., “device pose information,” based on the camera image and sensor data (such as data from a gyro sensor) mounted on the mobile device 200. The pose information generation module 230 extracts a feature from the camera image (continuous images) and calculates where the feature is located in the next image frame, thereby calculating a change in position. That is, the pose information generation module 230 may generate device pose information based on the feature extracted from the camera image. In addition, the pose information generation module 230 may generate the device pose information based on the sensor data. Since a relative value from previous frame data is generally obtained, current pose information may be calculated by accumulating the value. Since many errors occur when the device pose information is generated using only the camera image or the sensor data, the pose information generation module 230 generates the device pose information using both the camera image and the sensor data (e.g., gyro sensor data). The specific implementation methods vary depending on algorithms used.

The pose information generation module 230 generates the device pose information based on the camera image acquired by the camera 210 and the sensor data acquired by the sensor module 220 and transmits the generated device pose information to the rendering module 110.

The geometric information generation module 240 generates geometric information based on the camera image and the sensor data and transmits the generated geometric information to the image synthesis module 250. Here, the geometric information includes depth information of the real world based on the camera of the mobile device 200. The geometric information generation module 240 assumes that the position of the camera is fixed and calculates the position of objects/terrain, etc. in the real world to generate the geometric information. For example, the sensor data may be sensor data generated by a light detection and ranging (LiDAR) sensor or a time of flight (ToF) sensor. The specific sensor or algorithm used to generate the device pose information and the geometric information may vary depending on the mobile device. Therefore, the present disclosure does not impose limitations on the specific method of generating the device pose information and the geometric information.

The image synthesis module 250 receives a rendering image of a virtual object (a final color image and an AR depth image of the virtual object) transmitted by the rendering module 110, generates a mixed reality image based on the camera image, the geometric information, and the rendering image of the virtual object (the final color image and the AR depth image) and transmits the generated mixed reality image to the display module 260.

The display module 260 displays the mixed reality image generated by the image synthesis module 250 to the user of the mobile device 200.

The rendering module 110 of the rendering server 100 generates a rendering image of a virtual object (a final color image and an AR depth image of the virtual object) based on device pose information and 3D scene data of the virtual object. The rendering module 110 extracts the 3D scene data from the 3D scene DB 120 and uses the extracted 3D scene data in the rendering process.

The rendering module 110 of the rendering server 100 according to one embodiment of the present disclosure may use one of a direct rendering method and a virtual camera method.

The direct rendering method is a method of adding a new render pass (an AR render pass) for generating an AR image to the existing render pass, and generating a rendering image based on the two render passes.

The virtual camera method is a method of inserting a virtual camera in a 3D space and generating a rendering image using an image acquired from the virtual camera.

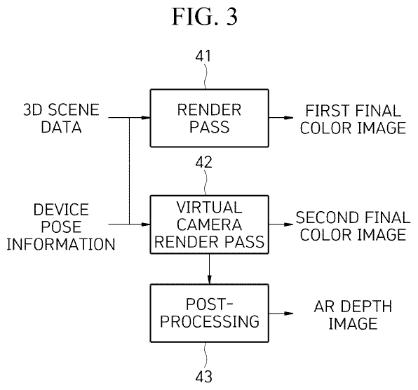

Hereinafter, the direct rendering method and the virtual camera method used by the rendering module 110 will be described with reference to FIGS. 2 and 3.

FIG. 2 is a reference diagram illustrating an AR image generation process through a direct rendering method of a rendering server according to one embodiment of the present disclosure.

The method of generating an AR image through a direct rendering method according to the embodiment of the present disclosure is a method of generating an AR image using scene depth and scene normal vector data generated after performing the render pass of the existing rendering engine. The direct rendering method is a method in which a screen rendered by the rendering server 100 is transmitted directly to the mobile device 200.

The rendering module 110 generates a rendering image of a virtual object (a final color image and an AR depth image of the virtual object) based on device pose information and 3D scene data of the virtual object.

As illustrated in FIG. 2, the rendering module 110 may generate a final color image and an AR depth image of a virtual object through a direct rendering method. In this case, the rendering module 110 performs a render pass 21 based on device pose information of the mobile device 200 received from the mobile device 200 and 3D scene data of a virtual object extracted from the 3D scene DB 120 to generate a final color image, a scene depth, and a scene normal vector. Then, the rendering module 110 performs an AR render pass 22 based on the scene depth and the scene normal vector to generate an AR depth image. The rendering module 110 may use the final color image in addition to the scene depth and the scene normal vector to generate the AR depth image. The rendering module 110 transmits the final color image and the AR depth image thus generated to the mobile device 200.

The render pass 21 used in the direct rendering method of FIG. 2 is a 3D render pass generally used in 3D engines and is not related to AR image generation. The present disclosure proposes a method and system for generating an AR image using an existing rendering engine (e.g., Unreal, Unity, or a self-developed engine) rather than a dedicated rendering engine. In addition, the AR render pass 22 used in the direct rendering method of FIG. 2 is not a pass for rendering an object itself represented in a 3D scene but is a pass for generating an AR depth image using a scene depth and a scene normal vector generated in the render pass 21.

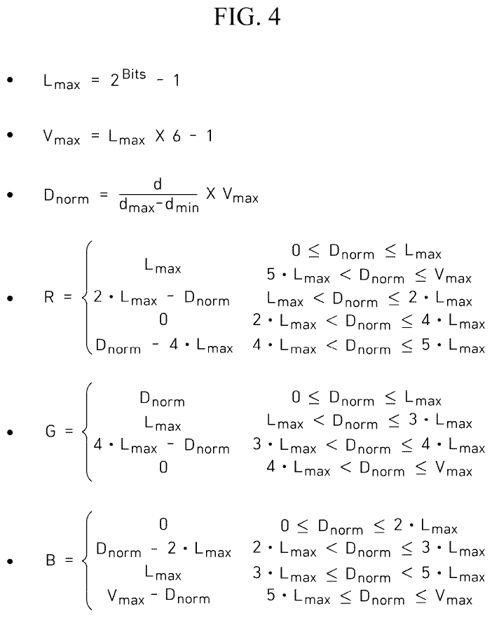

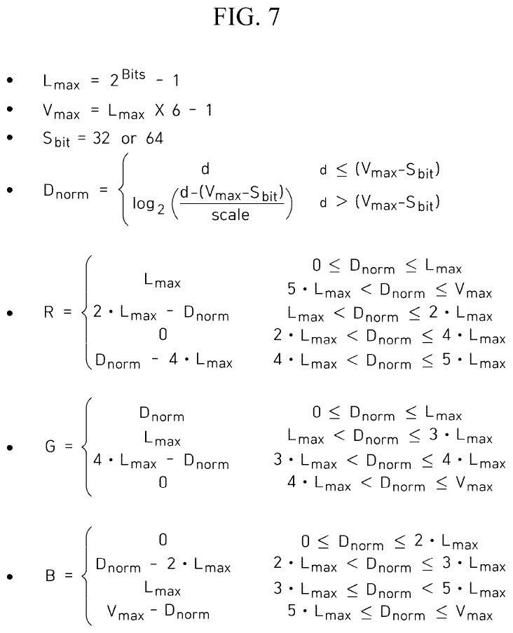

For reference, the scene depth is a depth value in a rendering engine for a 3D scene at a viewpoint at which the engine desires to perform rendering, and an AR depth (a depth value included in an AR depth image) is a converted value obtained by applying a depth image conversion algorithm shown in FIG. 4 or FIG. 7 to the scene depth.

Meanwhile, the scene normal vector is used to separate a background and a foreground (an AR object). When composing an AR scene, objects other than an object to be rendered are not represented or are excluded from the render pass through object filtering in the virtual camera. In this case, the AR image does not have a scene normal vector value in an area except for the AR object to be rendered, and for the area having no scene normal vector, a sufficiently large value that is physically impossible for the depth is arbitrarily assigned, to allow the separation of the object and the background in the AR image.

FIG. 3 is a reference diagram illustrating an AR image generation process through a virtual camera method of a rendering server according to one embodiment of the present disclosure.

A method of generating an AR image through a virtual camera method according to an embodiment of the present disclosure is a method of obtaining a rendering image at a specific point in time using a separate virtual camera provided by a 3D engine, and a screen displayed on the rendering server 100 may appear different from an actually generated screen.

As illustrated in FIG. 3, the rendering module 110 may generate a final color image (including a first final color image and a second final color image in the case of the virtual camera method of FIG. 3) and an AR depth image of a virtual object through the virtual camera method. In this case, the rendering module 110 performs a render pass 41 based on the device pose information of the mobile device 200 received from the mobile device 200 and the 3D scene data of the virtual object extracted from the 3D scene DB 120 to generate a first final color image. In addition, the rendering module 110 performs a virtual camera render pass 42 based on the device pose information of the mobile device 200 received from the mobile device 200 and the 3D scene data of the virtual object extracted from the 3D scene DB 120 to generate a second final color image.

The rendering module 110 performs post-processing 43 to generate an AR depth image. Although not shown in the drawing, the rendering module 110 generates the AR depth image through post-processing 43 based on a scene depth and a scene normal vector generated through the render pass 41 or the virtual camera render pass 42. In other words, the post-processing 43 has the same function as the AR render pass 22 shown in FIG. 2. However, the AR render pass 22 is included in the render pass of the rendering engine, different from the post-processing 43.

In addition to the above, the rendering module 110 may input all images generated in the previous render passes 41 and 42 into the post-processing 43 to generate an AR depth image.

The rendering module 110 transmits the second final color image and the AR depth image to the mobile device 200. Due to the nature of the virtual camera, the original render pass 41 and the virtual camera render pass 42 operate individually, and the first final color image is used for monitoring the rendering server 100.

The direct rendering method and the virtual camera method used by the rendering module 110 have been described with reference to FIGS. 2 and 3. The rendering module 110 may generate virtual object images in both the direct rendering method and the virtual camera method, but both methods have different advantages.

The direct rendering method (a render pass-based method) has a limitation that it is used only when using its own engine because the direct rendering method is implemented directly in the render pass but has a benefit of having a simple structure and being capable of rapid processing because the direct rendering method renders objects only once. In other words, in the direct rendering method, rendering of 3D objects is performed only once in the existing render pass 21, allowing for rapid processing.

In comparison, the virtual camera method has a relatively complex structure and requires rendering objects a plurality of times, which results in performance loss. However, the virtual camera method has a benefit of monitoring AR sessions and the like through server rendering and being easily applicable to commercial engines because the virtual camera method is implemented in a plug-in manner.

In addition, in the direct rendering method, the rendering process may be modified as needed, which enables insertion of an additional render pass (an AR render pass 22) into the rendering process, thereby achieving a desired result at once.

On the other hand, in the case of the virtual camera method, it is not possible to intervene in the rendering process itself performed by the virtual camera, and only the rendered result may be accessed. Therefore, the method of generating an AR image using the virtual camera method generates an AR depth image through a separate task referred to as post-processing 43 after the virtual camera render pass 42, that is, after all rendering processes are completed.

FIG. 4 is a diagram of a depth image representation algorithm, illustrating a transformation formula for generating a depth image based on depth information.

Different spatial units are used depending on the rendering engine. For example, ARCore uses a spatial unit of 1 m, and Unreal Engine uses a spatial unit of 1 cm. Using smaller units allows for a more sophisticated representation of AR objects.

The transformation formula of FIG. 4 is a general formula for the transformation formula described in FIG. 4 of the applicant's application [2]. Through the transformation formula of FIG. 4, depth information may be converted into a desired length unit (m, cm, etc.), and then subjected to signal quantization, and the depth information converted into an integer format by quantization may be converted for a color space.

The rendering module 110 may generate an AR depth image of a virtual object according to the transformation formula of FIG. 4. The rendering module 110 may obtain R, G, and B values based on the depth information (a scene depth) of the virtual object according to the transformation formula illustrated in FIG. 4 and may generate a colorized depth image using the obtained R, G, and B values.

The reason for encoding the depth value as RGB values is to represent a wide range. For example, depth information is represented in a range of 256 based on 8 bits, and in a range of 1024 based on 10 bits, thus having a very low resolution. When the depth value is encoded as RGB values, a wider range may be represented. For example, when encoded as RGB values, representation is possible in a range of 1529 based on 8 bits and in a range of 6143 based on 10 bits, and decoding to the original depth value is also possible.

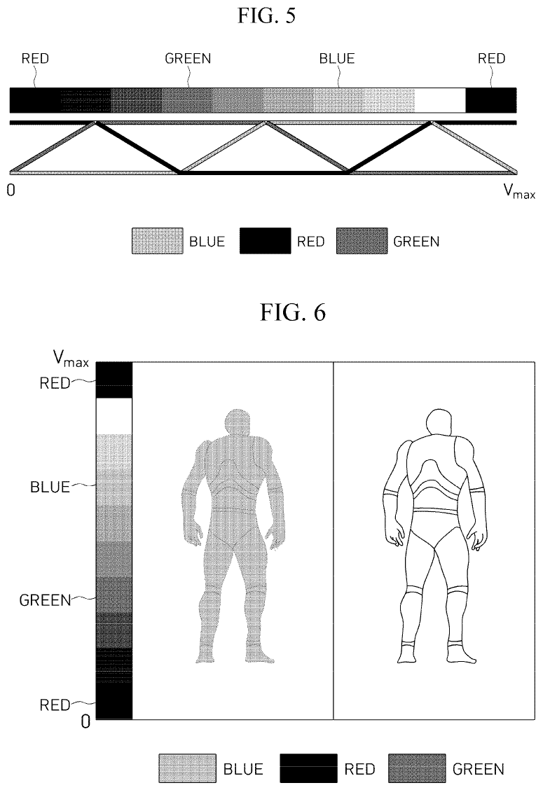

FIG. 5 is a diagram illustrating changes in RGB values according to a depth image representation algorithm. Referring to FIG. 5, it can be seen that the combination of four states (0, maximum, increase, and decrease) of RGB values may be uniquely set in all sections, allowing for decoding to the original depth value. FIG. 6 is an example illustrating the application of a depth image representation algorithm shown in FIG. 4 to an actual object.

When following the algorithm of FIG. 4, the RGB values change naturally, and thus high efficiency in image encoding may be expected, and AR objects corresponding to a short distance may be represented. When using a unit of 1 cm, approximately 15 m may be represented with 8 bits and approximately 61 m may be represented with 10 bits.

However, since the real-world space is larger than the above-described range, a wider range needs to be represented. In order to represent a wider range of depth, the rendering server 100 according to one embodiment of the present disclosure introduces an algorithm that utilizes the last portion of the representable range.

FIG. 7 is a diagram illustrating a depth image representation algorithm. The transformation formula of FIG. 7 may represent a wider range than the transformation formula of FIG. 4. The depth image representation algorithm represented with the transformation formula of FIG. 7 may be used in both the AR render pass 22 of the direct rendering method and the post-processing 43 of the virtual camera method.

The transformation formula of FIG. 7 employs the transformation formula of FIG. 4 for the RGB transformation formula of Dₙₒᵣₘ values in the remaining range except for a bit count S_{bit} of 32 or 64 in the representation range limit. The last 32 or 64 value is converted to a log scale value using log₂(⋅). The bit count 32 or 64 is set considering the bit count supported by the shader. A value d, which is applied to the log function, is substituted with an increase from the last value of the existing algorithm representation so as not to include the existing depth value, and the finally changed depth value is converted to an RGB value through the existing algorithm. By fixing the S_{bit} value to 32 or 64, fast processing is performed using the shift operation (<<) during decoding. In addition, the precision of the depth value represented in the log scale may be adjusted by adjusting the scale value. The scale value is a variable for adjusting the degree of conversion during log scale conversion, has a default value of 1, and may be set to a value greater than 1. The algorithm of FIG. 4 (the application [2]) is an algorithm designed to store an AR object in the form of an image, and aims to represent a single AR object, and thus it is sufficient to represent only a relatively short distance (e.g., 15 m). However, since the method of generating an AR image according to the present disclosure needs to represent an area visible from the viewpoint of the remote mobile device 200, there is a need to represent a long distance (e.g., 150 m). Therefore, through the algorithm of FIG. 7, the existing transformation formula is applied in a short distance, and for distances beyond a certain range, a log scale is used, thereby lowering the precision and representing a wide range.

The algorithm (the transformation formula) of FIG. 7 may be used in both the AR render pass 22 of the direct rendering method of FIG. 2 and the post-processing 43 of the virtual camera method of FIG. 3.

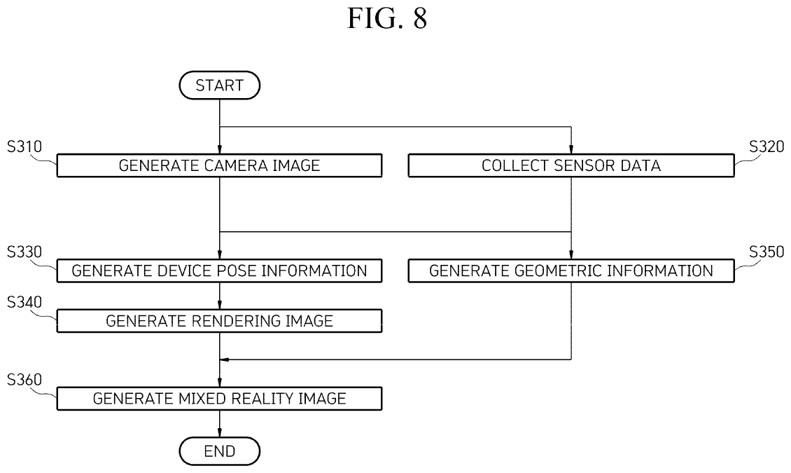

FIG. 8 is a flowchart for describing a method of generating an AR image according to one embodiment of the present disclosure.

Referring to FIG. 8, the method of generating an AR image according to an embodiment of the present disclosure includes operations S310 to S360. The method of generating an AR image shown in FIG. 8 is based on one embodiment, and operations of the method of generating an AR image according to the present disclosure are not limited to the embodiment shown in FIG. 8, and some operations may be added, changed, or deleted as needed.

Operation S310 is an operation of generating a camera image.

The camera 210 generates an image (“a camera image”) of the surroundings of the mobile device 200 and transmits the image to the pose information generation module 230, the geometric information generation module 240, and the image synthesis module 250.

Operation S320 is an operation of collecting sensor data.

The sensor module 220 includes one or a combination of a gyro sensor, a geomagnetic sensor, and an acceleration sensor, and transmits sensor data acquired using the sensor to the pose information generation module 230 and the geometric information generation module 240.

Operation S330 is an operation of generating device pose information.

The pose information generation module 230 generates device pose information based on the camera image acquired by the camera 210 and the sensor data acquired by the sensor module 220 and transmits the generated device pose information to the rendering module 110.

Operation S340 is an operation of generating a rendering image.

The rendering module 110 of the rendering server 100 generates a rendering image of a virtual object (a first final color image, a second final color image, and an AR depth image of the virtual object) based on the device pose information and the 3D scene data of the virtual object. The rendering module 110 extracts 3D scene data from the 3D scene DB 120 and uses the extracted 3D scene data in the rendering process. The rendering module 110 transmits the second final color image and the AR depth image to the mobile device 200. The first final color image is used for monitoring the rendering server 100.

Operation S350 is an operation of generating geometric information.

The geometric information generation module 240 generates geometric information based on the camera image and the sensor data and transmits the generated geometric information to the image synthesis module 250.

Operation S360 is an operation of generating a mixed reality image.

The image synthesis module 250 receives the rendering image of the virtual object (the second final color image and the AR depth image of the virtual object) transmitted by the rendering module 110 and generates a mixed reality image based on the camera image, the geometric information, and the rendering image of the virtual object (the second final color image and the AR depth image). Then, the image synthesis module 250 transmits the mixed reality image to the display module 260 to allow the display module 260 to display the mixed reality image.

The method of generating an AR image has been described above with reference to the flowcharts presented in the drawings. While the above method has been shown and described as a series of blocks for the purpose of simplicity, it is to be understood that the present disclosure is not limited to the order of the blocks, and that some blocks may be executed in a different order from that shown and described herein or executed concurrently with other blocks, and various other branches, flow paths, and sequences of blocks that achieve the same or similar results may be implemented. In addition, not all illustrated blocks are necessarily required for implementation of the method described herein.

Meanwhile, in the description with reference to FIG. 8, each operation may be further divided into a larger number of sub-operations or combined into a smaller number of operations according to examples of implementation of the present disclosure. In addition, some of the operations may not be performed or the order of operations may be changed as needed. In addition, even in the case of omitted content, the content of FIGS. 1 to 7 may be applied to the content of FIG. 8. In addition, the content of FIG. 8 may be applied to the content of FIGS. 1 to 7.

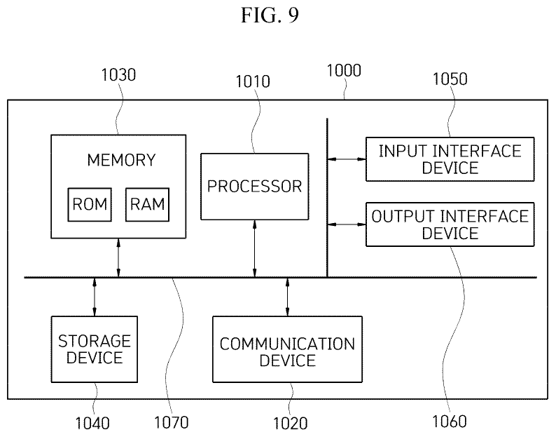

FIG. 9 is a block diagram illustrating a computer system for implementing a method of generating an AR image according to an embodiment of the present disclosure. The rendering server 100 or the mobile device 200 may be implemented in the form of the computer system shown in FIG. 9.

Referring to FIG. 9, the computer system 1000 may include at least one of a processor 1010, a memory 1030, an input interface device 1050, an output interface device 1060, and a storage device 1040 that communicate through a bus 1070. The computer system 1000 may further include a communication device 1020 coupled to a network. The processor 1010 may be a central processing unit (CPU) or a semiconductor device for executing instructions stored in the memory 1030 and/or storage device 1040. The memory 1030 and the storage device 1040 may include various forms of volatile or nonvolatile media. For example, the memory may include a read only memory (ROM) or a random access memory (RAM). In an embodiment of the present disclosure, the memory may be located inside or outside the processor and may be connected to the processor through various known means. The memory may include various forms of volatile or nonvolatile media, for example, may include a ROM or a RAM.

Accordingly, the embodiments of the present disclosure may be embodied as a method implemented by a computer or non-transitory computer readable media in which computer executable instructions are stored. According to an embodiment, when executed by a processor, computer readable instructions may perform a method according to at least one aspect of the present disclosure.

The communication device 1020 may transmit or receive a wired signal or a wireless signal.

In addition, the method according to the present disclosure may be implemented in the form of program instructions executable by various computer devices and may be recorded on computer readable media.

The computer readable media may be provided with program instructions, data files, data structures, and the like alone or in combination. The program instructions recorded on the computer readable media may be specially designed and constructed for the purposes of the present disclosure or may be well known and available to those skilled in the art of computer software. The computer readable storage media include hardware devices configured to store and execute program instructions. For example, the computer readable storage media include magnetic media such as hard disks, floppy disks, and magnetic tape, optical media such as a CD-ROM and a DVD, magneto-optical media such as floptical disks, a ROM, a RAM, a flash memory, etc. The program instructions include not only machine language code made by a compiler but also high level code that may be used by an interpreter etc., which is executed by a computer.

As is apparent from the above, according to one embodiment of the present disclosure, a low-spec mobile AR device can play back a high-quality AR object through a method in which a rendering server renders an AR object, and transmits a rendering result image in a 2D format to a mobile device, and the mobile device decodes the received image and synthesizes the decoded image with its own camera image to output the synthesized image.

According to one embodiment of the present disclosure, a wider range can be represented, and the alignment between AR objects and the real world can be effectively achieved by encoding a depth image, which is transmitted from a rendering server to a mobile device, in RGB values,

The effects of the present disclosure are not limited to those described above, and other effects that are not described above will be clearly understood by those skilled in the art from the above detailed description.

Although the present disclosure has been described in detail above with reference to exemplary embodiments, those of ordinary skill in the technical field to which the present disclosure pertains should be able to understand that various modifications and alterations may be made without departing from the technical spirit and scope of the present disclosure.

What is claimed is:

1. A method of generating an augmented reality (AR) image, comprising:
generating, by a mobile device, based on a camera image and sensor data collected from a camera and a sensor mounted on the mobile device, pose information of the mobile device and geometric information of the camera image;
generating, by a rendering server, a color image and a depth image of a virtual object based on the pose information and 3D scene data of the virtual object; and
generating, by the mobile device, a mixed reality image based on the color image, the depth image, the camera image, and the geometric information.

2. The method of claim 1, wherein generating of the color image and the depth image includes:
performing, by the rendering server, a render pass based on the pose information and the 3D scene data of the virtual object to generate the color image, a scene depth, and a scene normal vector; and
performing an AR render pass based on the color image, the scene depth, and the scene normal vector to generate the depth image.

3. The method of claim 1, wherein the depth image of the virtual object is a colorized depth image.

4. The method of claim 1, wherein the depth image of the virtual object is represented on a log scale when depth information of a specific point included in the depth image of the virtual object is greater than a predetermined reference value.

5. A system for generating an augmented reality (AR) image, comprising:
a mobile device; and
a rendering server,
the mobile device, based on a camera image and sensor data collected from a camera and a sensor mounted on the mobile device, configured to generate pose information of the mobile device and geometric information of the camera image,
the rendering server configured to generate a color image and a depth image of a virtual object based on the pose information and 3D scene data of the virtual object, and
the mobile device configured to generate a mixed reality image based on the color image, the depth image, the camera image, and the geometric information.

6. The system of claim 5, wherein the rendering server is configured to:
perform a render pass based on the pose information and the 3D scene data of the virtual object to generate the color image, a scene depth, and a scene normal vector, and
perform an AR render pass based on the color image, the scene depth, and the scene normal vector to generate the depth image.

7. The system of claim 5, wherein the depth image of the virtual object is a colorized depth image.

8. The system of claim 5, wherein the depth image of the virtual object is represented on a log scale when depth information of a specific point included in the depth image of the virtual object is greater than a predetermined reference value.
